(19) United States
(12) Patent Application Publication
(10) Pub. No.: US 2012/0242000 A1
(43) Pub. Date: Sep. 27, 2012

(54) FPC CONNECTOR MANUFACTURING METHOD

(75) Inventors: Shintaro KOMATSU, Ibaraki (JP); Hiroshi HARADA, Ibaraki (JP)

(73) Assignee: SUMITOMO CHEMICAL COMPANY, LIMITED, Tokyo (JP)

(21) Appl. No.: 13/423,796

(22) Filed: Mar. 19, 2012

(30) Foreign Application Priority Data
Mar. 22, 2011 (JP) P2011-62306

(51) Int. Cl. B29C 45/14

(52) U.S. Cl. 264/272.11

(57) ABSTRACT

An FPC connector is manufactured by pouring a resin material into a cavity defined by a mold through a gate formed to the mold so as to fill the cavity to thereby perform an injection molding of the FPC connector. In the manufacture, a mold to which a single gate is formed is used, and the gate is formed at a position between one end portion of the cavity and a portion apart inside by 15/100 of a full length of the cavity from one end in a longitudinal direction thereof. A liquid crystalline polyester may be preferable used as the resin material.

### BACKGROUND OF THE INVENTION

1. Field of the Invention

The present invention relates to an FPC (flexible printed circuit) connector manufacturing method, and more particularly, to a method of manufacturing an FPC connector, through an injection molding process by filling a cavity of a mold with a resin via a gate, in which the FPC connector means a connector used for an FPC assembled in various kinds of electric and/or electronic devices.

2. Related Art

The FPC connectors of the kinds mentioned above have an advantage of making low in height at a time of connection thereof and so have been widely adopted and utilized for smart phones, digital cameras, game machines and other kinds of electric and/or electronic devices keeping getting smaller and smaller. A recent FPC connector of such kind has a narrow pitch distance between pin insertion holes, and so, in a case where the FPC connector has a fine warpage, such warpage may result in defect in soldered condition in a reflow process. Because of this reason, it has been strongly desired to possibly reduce such warpage of the FPC connector at the time of manufacture thereof.

In order to obviate such defect, in a conventional technology, there have been adopted a method in which a gate is provided at a portion near a central portion of a cavity of a mold for lowering a flowing pressure of a resin into the mold to thereby evenly flow the resin, or a method in which a mold having a plurality of gates is used for lowering the flowing pressure of the resin into the mold to thereby make small residual stress.

Furthermore, there is also provided a technology utilizing an arrangement in which a gate of a mold is not formed on a bisector in a longitudinal or depth direction formed of a cavity of the mold, and any weld line (the line where two flow fronts meet and not weld together) is not generated on this bisector of the mold, for example, as disclosed in Japanese Patent Application Laid-open Publication No. 2009-181847 (Patent Document 1).

However, at a time when a weld line is formed at the resin flowing process, even if the weld line does not exist on the bisector of the mold, it is to be considered that the warpage of the FPC connector is increased, and hence, the technology proposed in the Patent Document 1 provides such an inconvenience that it is difficult to sufficiently reduce the warpage of the FPC connector, thus being disadvantageous.

### SUMMARY OF THE INVENTION

Accordingly, the present invention was conceived in consideration of the circumstances encountered in the prior art mentioned above, and an object thereof is to provide an FPC connector manufacturing method capable of possibly reducing amount of warpage of an FPC connector at a time of performing an injection molding of a resin material, for example, into a mold.

This and other objects can be achieved according to the present invention by providing a method of manufacturing an FPC connector in which resin material is poured into a cavity defined by a mold through a gate formed to the mold so as to fill the cavity to thereby perform an injection molding of the FPC connector, wherein the injection molding is performed with using the mold comprising single gate formed at a position between one end portion of the cavity and a portion apart inside by 15/100 of a full length of the cavity from one end in a longitudinal direction thereof.

In a preferred embodiment, it may be desired that the resin material is a liquid crystalline polyester.

The resin material may be a liquid crystalline polyester compound which is prepared by combining the liquid crystalline polyester with at least one of filler selected from glass fiber, talc, and mica.

It may be desired that the gate is formed on a bisector in a depth direction of the cavity of the mold.

It is desirable that the thus manufactured FPC connector has pin insertion holes of 10 or more than 10 in number and the pin insertion hole has a pitch of not more than 0.6 mm.

According to the present invention of the characters mentioned above, when the FPC connector is manufactured by the injection molding process, the FPC connector is molded by being orientated in the longitudinal direction of the cavity because the resin flows from a portion near one end of the cavity toward the other end thereof in the cavity. In this injection molding, since only one (single) gate is formed to the mold at the predetermined position of the mold (i.e., cavity), warpage of an FPC connector originated by the presence of a weld line can be obviated, and as a result, the amount of warpage can be effectively sufficiently reduced, thus being advantageous.

The nature and the further characteristic features of the present invention will be made clearer from the following descriptions made with reference to the accompanying drawings.

### BRIEF DESCRIPTION OF THE DRAWINGS

In the accompanying drawings:

FIGS. 1A to 1C are illustrations of an FPC connector according to one embodiment of the present invention, in which FIG. 1A is a plan view of the FPC connector, FIG. 1B is a front view thereof, and FIG. 1C is a right side view thereof; and

FIGS. 2A and 2B are illustrations for explaining an FPC connector manufacturing method, in which FIG. 2A is a perspective view of a cavity of a mold and FIG. 2B is a front view thereof.

### DESCRIPTION OF THE PREFERRED EMBODIMENT

Hereunder, a preferred embodiment of the present invention will be described with reference to the accompanying drawings.

### First Embodiment

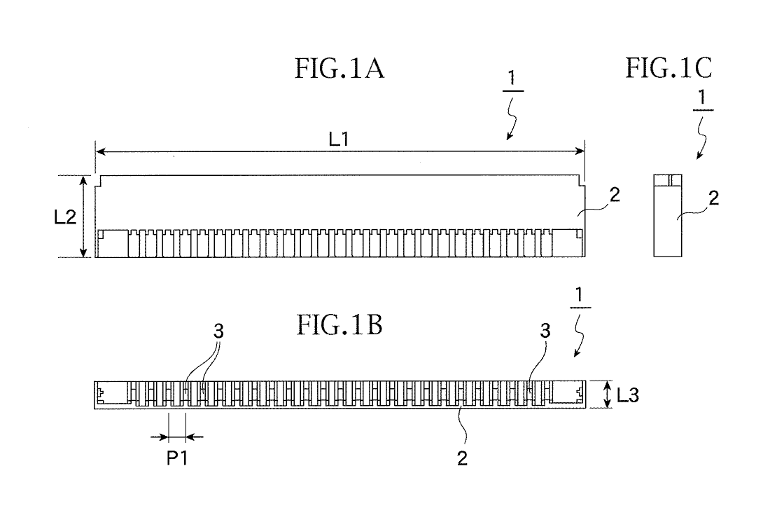

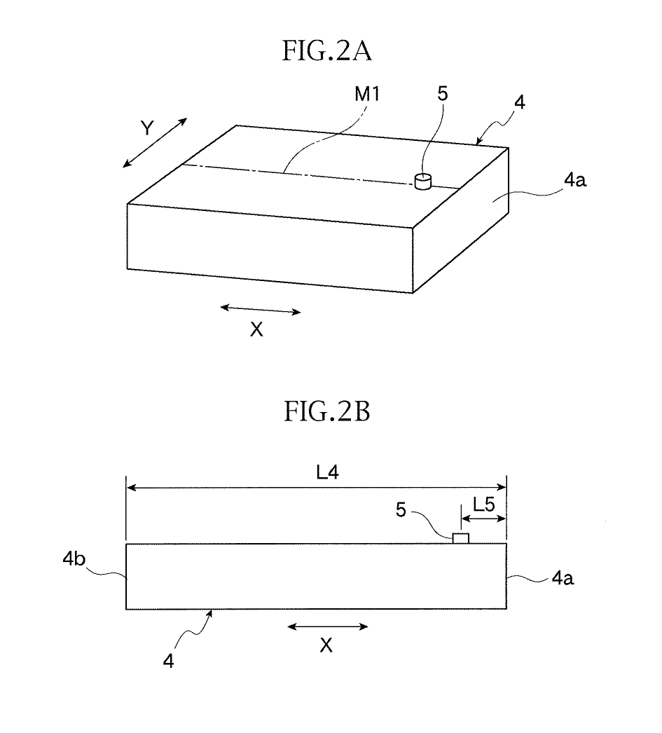

FIGS. 1A to 2B represent a first embodiment of the present invention, and it is to be noted that dimensional ratio of a cavity 4, mentioned hereinafter, shown in FIGS. 2A and 2B are not necessarily correct or precise because of clear understanding of the embodiment.

With reference to FIGS. 1A and 1B, an FPC (flexible printed circuit) connector 1 has a connector body 2 having a longitudinal length L1 (L1=18 mm, for example), a depth L2 (L2=3 mm, for example), and a height L3 (L3=1 mm, for example). The connector body 2 is formed with a plurality of insertion holes 3 (for example, 25 insertion holes 3) in parallel with each other with a predetermined pitch P1 (P1=0.6 mm, for example) between adjacent insertion holes 3.

The FPC connector 1 is manufactured by injection-molding liquid crystalline polyester. The liquid crystalline polyester is a polyester which shows crystallinity in a melt (fused) state, and preferably, a polyester which fuses at a temperature of not more than 450° C. Further, this liquid crystalline polyester may be liquid crystalline polyester amide, liquid crystalline polyester ether, liquid crystalline polyester carbonate, or liquid crystalline polyester imide, and it is preferable that the liquid crystalline polyester is a wholly aromatic liquid crystalline polyester formed by using only an aromatic compound as raw monomer.

As a typical example of the liquid crystalline polyester, there will be listed up: one that is prepared by polymerizing (polycondensation) aromatic hydroxy carboxylic acid, aromatic dicarboxylic acid, and at least one kind of compounds selected from a group consisting of aromatic diol, aromatic hydroxylamine and aromatic diamine; one that is prepared by polymerizing plural kinds of aromatic hydroxy carboxylic acid; one that is prepared by polymerizing aromatic dicarboxylic acid and at least one kind of compounds selected from a group consisting of aromatic diol, aromatic hydroxylamine and aromatic diamine; and one that is prepared by polymerizing polyester such as polyethylene terephthalate and aromatic hydroxy carboxylic acid. Herein, instead of a part of or all of the aromatic hydroxy carboxylic acid, the aromatic dicarboxylic acid, the aromatic diol, the aromatic hydroxylamine and the aromatic diamine, the polymerizable derivative thereof can be utilized respectively independently.

Further, as an example of the polymerizable derivative of a compound having carboxyl group such as aromatic hydroxy carboxylic acid and aromatic dicarboxylic acid, there will be listed up: one (ester) of which carboxyl group is transformed to alkoxylcarbonyl group or aryloxycarbonyl group; one (acid halide) of which carboxyl group is transformed to haloformyl group; and one (acid anhydride) of which carboxylic group is transformed to acyloxycarbonyl group. Furthermore, as an example of the polymerizable derivative of a compound having hydroxyl group such as aromatic hydroxy carboxylic acid, aromatic diol and aromatic hydroxylamine, there will be listed up one (acylated compound) in which hydroxyl group is acylated and transformed to acyloxyl group. As an example of the polymerizable derivative of a compound having amino group such as aromatic hydroxylamine and aromatic diamine, there will be listed up one (acylated compound) such as one in which the amino group is acylated and transformed to acylamino group.

It is preferable for the liquid crystalline polyester to have a repeat (repeating) unit represented by the following formula (1) (called “repeat unit (1)” hereunder), and it is further preferable for the liquid crystalline polyester to have a repeat unit (2) represented by the following formula (2) (called “repeat unit (2) hereunder) and a repeat unit (3) represented by the following formula (3) (called “repeat unit (3) hereunder) in addition to the repeat unit (1).

—O—Ar¹—CO— (1)

—CO—Ar²—CO— (2)

—X—Ar³—Y— (3)

wherein Ar¹ represents phenylene group, naphthylene group or biphenylylene group, and Ar² and Ar³ are represent independently phenylene group, naphthylene group, biphenylylene group or a group represented by the following formula (4), and wherein X and Y represent independently oxide atom or imino group (—NH—). Hydrogen atoms in the above mentioned groups may be independently displaced with halogen atom, alkyl group or aryl group, respectively.

—Ar⁴—Z—Ar⁵— (4)

wherein Ar⁴ and Ar⁵ independently represent phenylene group and naphthylene group, respectively, and Z represents oxide atom, sulfur atom, carbonyl group, sulfonyl group or alkylidene group.

As an example of the halogen atom, there will be listed up fluorine atom, chlorine atom, bromine atom and iodine atom. As an example of the alkyl group, there will be listed up methyl group, ethyl group, n-propyl group, isopropyl group, n-butyl group, isobutyl group, s-butyl group, t-butyl group, n-hexyl group, 2-ethylhexyl group, n-octyle group, and n-decyl group, the carbon numbers of which are usually 1 to 10. As an example of the aryl group, there will be listed up phenyl group, o-tolyl group, m-tolyl group, p-tolyl group, 1-naphthyl group, and 2-naphtyl group, the carbon numbers of which are usually 6 to 20. In a case where the hydrogen atoms are displaced with these groups, the number of the hydrogen atoms is usually not more than 2, and preferably, not more than 1, for each of the groups represented by Ar¹, Ar² and Ar³.

Furthermore, as an example of the alkylidene group, there will be listed up methylene group, ethylidene group, isopropylidene group, n-butylidene group and 2-ethylhexylidene group, the carbon number of which are usually 1 to 10.

The repeat unit (1) is a repeat unit derived from a predetermined aromatic hydroxy carbonyl acid, and as the repeat unit (1), one, in which Ar¹ is p-phenylene group (i.e., repeat unit derived from p-hydroxyl benzoic acid) and Ar¹ is 2,6-naphthylene group (i.e., repeat unit derived from 6-hydroxyl-2-naphtoe acid), is preferred.

The repeat unit (2) is a repeat unit derived from a predetermined aromatic dicarboxylic acid, and as the repeat unit (2), one, in which Are is p-phenylene group (i.e., repeat unit derived from terephthalic acid) and Ar² is m-phenylene group (i.e., repeat unit derived from isophthalic acid), Ar² is 2,6-naphthylene group (i.e., repeat unit derived from 2, 6-Naphthalenedicarboxylic acid), and Ar² is diphenylether-4,4′-diyl group (i.e., repeat unit derived from diphenylether-4,4′-dicarboxylic acid), is preferred.

The repeat unit (3) is a repeat unit derived from a predetermined aromatic diol, aromatic hydroxylamine or aromatic diamine, and as the repeat unit (3), one, in which A³ is p-phenylene group (i.e., repeat unit derived from hydroquinone, p-aminophenol or p-phenylenediamine), and Ar³ is 4, 4′-biphenylylene group (i.e., repeat unit derived from 4,4′-dihydroxybyphenyl, 4-amino-4′-hydroxybyphenyl or 4,4′-diaminobiphenyl).

A contained amount of the repeat unit (1) is usually 30 mol % or more, and preferably, 30-80 mol %, more preferably 40-70 mol %, and further preferably, 45-65 mol % with respect to total contained amount of all repeat units (the total amount obtained by totalizing the values corresponding to amounts of substance (i.e., mole) of the repeat units contained in the liquid crystalline polyester, in which each value is calculated by dividing mass of the repeat unit by formula weight of the repeat unit). A contained amount of the repeat unit (2) is usually 35 mol % or less, and preferably, 10-35 mol %, more preferably 15-30 mol %, and further preferably, 17.5-27.5 mol % with respect to total contained amount of all repeat units. A contained amount of the repeat unit (3) is usually 35 mol % or less, and preferably, 10-35 mol %, more preferably 15-30 mol %, and further preferably, 17.5-27.5 mol % with respect to total contained amount of all repeat units. It is to be noted that the increment of contained amount of the repeat unit (1) improves the melt flow property, heat-proof characteristics, strength and rigidity. However, if the contained amount of the repeat unit (1) becomes excess, the melt temperature and melt viscosity increases and so the necessary temperature for molding rises.

The ratio between the contained amounts of the repeat unit (2) and the repeat unit (3) is represented by [contained amount of repeat unit (2)]/[contained amount of repeat unit (3)](mol/mol), and it is preferred that the ratio is usually 0.9/1 to 1/0.9, preferably 0.95/1 to 1/0.95, and more preferably 0.98/1 to 1/0.98.

Further, the liquid crystalline polyester may be provided independently with two or more kinds of repeat units (1) to (3), and moreover, the liquid crystalline polyester may be provided with repeat units other than the repeat units (1) to (3), but in such case, the contained amount thereof is usually not more than 10 mol % or preferably not more than 5 mol % with respect to the total contained amount of the all the repeat units.

It is further preferred that the liquid crystalline polyester includes the repeat units (3) of which “X” and “Y” are oxygen atoms respectively, that is, the liquid crystalline polyester includes repeat units derived from predetermined aromatic diol, because of low melt viscosity, and it is more preferred that the liquid crystalline polyester includes only the repeat units of which “X” and “Y” are oxygen atoms respectively as the repeat unit (3).

Furthermore, it is also preferred that the liquid crystalline polyester is manufactured by performing melt polymerization of raw material monomer corresponding to the repeat units constituting the liquid crystalline polyester and then by performing solid-phase polymerization of a polymeric substance obtained thereby. According to such manufacturing manner, a high-molecular-weight liquid crystalline polyester having improved heat resisting property, strength and rigidity can be manufactured with simple operation. The melt polymerization may be performed under existence of a catalyst, and as a catalyst, there will be listed up: metal compound such as magnesium acetate, stannous acetate, tetrabutyltitanate, lead acetate, sodium acetate, potassium acetate or antimony trioxide; or nitrogen-containing heterocyclic compound such as 4-(dimethylamine) pyridine or 1-methylimidazol. The nitrogen-contained heterocyclic compound being preferably used as the catalyst.

It is desirable that the liquid crystalline polyester has a fluid flowing starting temperature of usually not less than 270° C., preferably 270 to 400° C., and more preferably, 280 to 380° C. In a case of this flow starting temperature is as far as high, the heat-resisting property, strength and rigidity will be easily improved. However, in a case of too high flow starting temperature, the melt temperature and melt viscosity will likely become high, which may result in increasing of temperature necessary for a molding processing of the liquid crystalline polyester.

Further, the fluid flowing starting temperature is also called “flow temperature” or “fluid flow temperature”, and this temperature represents a viscosity of 4800 Pa·s (4800 poise) at a time when the liquid crystalline polyester is melt and pushed out through a nozzle having an inner diameter of 1 mm and length of 10 mm while heating a temperature under load of 9.8 MPa (100 kgf/cm²) and speed of 4° C./min by using a capillary rheometer, and this fluid flowing starting temperature is a guide for molar weight of the liquid crystalline polyester (for example, refer to “liquid crystalline polymer—composition•molding•application—”, by Naoyuki KOIDE, pp. 95-105, published from CMC K.K., May 6, 1987).

Hereunder, a manufacturing method of the FPC connector 1 of the characters mentioned above will be described with referencing FIGS. 2A and 2B. FIGS. 2A and 2B conceptually show a cavity and a gate according to the present embodiment. As is well known, the term ‘cavity’ means an internal space of a mold into which a mold material is poured via a gate. In FIGS. 2A and 2B, the mold is not represented except a cavity 4 and a gate 5 to facilitate understanding of the present embodiment.

First, a predetermined mold is prepared. This mold is composed of a vertically pair of mold halves, i.e., upper and lower mold halves, which can be opened and closed. When these mold halves are closed, as shown in FIGS. 2A and 2B, a cavity 4 having a shape corresponding to a shape of the FPC connector 1 is formed inside the closed mold halves. In the mold, only one gate 5 is formed to the upper mold half. The gate 5 is positioned, as shown in FIG. 2A, on a bisector M1 in the depth direction of the cavity 4 (Y-arrow direction), and as also shown in FIG. 2B, positioned on a place left a predetermined distance L5 from one end 4a of the cavity 4 toward inside (another one end 4b side) in the longitudinal direction (X-arrow direction) of the cavity 4. The distance L5 is herein not more than 15/100 (15%) of the entire length L4 of the cavity 4, i.e., to satisfy 0≦L5/L4≦15/100.

In the next stage, the paired upper and lower mold halves are closed and the cavity 4 is formed in the mold. Then, the liquid crystalline polyester is poured into the mold and fills the cavity 4 through the gate 5. Consequently, the liquid crystalline polyester filling the cavity 4 flows from a portion near the one end 4a of the cavity 4 toward the other end 4b thereof, and so the liquid crystalline polyester molecules are oriented in the longitudinal direction of the cavity 4 (i.e., the direction parallel to the X-arrow).

Thereafter, the liquid crystalline polyester is cooled. As a result, the liquid crystalline polyester is solidified in the cavity 4 with the state oriented in the longitudinal direction of the cavity 4.

Finally, the closed mold halves are opened to take out a liquid crystalline polyester resin, thus obtaining an FPC connector 1 formed of the liquid crystalline polyester.

As described above, in the manufacture of the FPC connector 1, the FPC connector 1 is formed in solid state in which the liquid crystalline polyester oriented in the longitudinal direction of the cavity 4, thus reducing the warpage of the FPC connector 1 in the longitudinal direction thereof. Accordingly, a soldering failure will be prevented from causing during the reflow process of the FPC connector 1.

In addition, since the mold is formed with only one gate 5, any weld line is not formed when the liquid crystalline polyester is poured in the FPC connector manufacturing process, whereby the increase of the warpage of the FPC connector 1 which may be caused from the existence of the weld line can be effectively obviated.

Moreover, the liquid crystalline polyester filling the cavity 4 as a raw material of the FPC connector 1 has a superior characteristic in orientation in comparison with commodity resin, and accordingly, the use of the liquid crystalline polyester as the raw material of the FPC connector 1 can further contribute to the reduction of the warpage of the FPC connector 1.

### ANOTHER EMBODIMENT OF THE INVENTION

Further, it is to be noted that although, in the embodiment described hereinbefore, the liquid crystalline polyester is used as a resin that fills the cavity 4 of the mold, resins other than liquid crystalline polyester, for example, polyamide, may be used in replacement of the liquid crystalline polyester.

Furthermore, it may be possible to use a liquid crystalline polyester resin compound prepared by combining the liquid crystalline polyester with another component such as filler, additive, or resins other than the liquid crystalline polyester. In a case where the liquid crystalline polyester is combined with the filler, the liquid crystalline polyester is reinforced by the filler, so that the possibility of warpage of the FPC connector 1 can be further reduced.

As such filler, fiber-shaped filler, plate-shaped filler, or spherical or other granular filler may be used. Moreover, inorganic filler or organic filler may be also used. As an example of the fiber-shaped inorganic filler, there will be listed up: glass fiber; carbon fiber such as pan-series carbon fiber and pitch-series carbon fiber; silica fiber; alumina fiber; ceramic fiber such as silica-alumina fiber or like; and metal fiber such as stainless fiber. In addition, there will be also listed up: or whiskers such as potassium titanate whisker, barium titanate whisker, wollastonite whisker; aluminium borate whisker; silica nitride whisker or silica carbonate whisker. As an example of the fiber-shaped organic fiber, there will be also listed up: polyester fiber or aramid fiber. As an example of the plate-like filler, there will be listed up: talc; mica; graphite; wollastonite; glass flake; barium sulfate; or calcium carbonate. Herein, as the mica, white mica, gold mica, fluoro gold mica or tetrasilisic mica. As an example of the granular inorganic filler, there will be listed up: silica; alumina; titanium oxide; glass beads; glass balloon; boron nitride; silica carbonate; or calcium carbonate. The contained amount of the filler is usually of 0 to 100 parts by mass with respect to the 100 parts by mass of the liquid crystalline polyester.

As an example of the additive, there will be also listed up: antioxidant; heat stabilizer; ultraviolet absorber; antistatic; surface activating agent; fire retardant; or coloring agent. The contained amount of the additive is usually of 0 to 5 parts by mass with respect to the 100 parts by mass of the liquid crystalline polyester.

It is desirable for the liquid crystalline polyester resin compound to be prepared by melting and kneading the liquid crystalline polyester and other components, which may be added as occasion demands, and then extruded by using an extruder so as to provide a pellet geometry. A preferable extruder may include a cylinder, one or more screws disposed inside the cylinder and one or more supply ports formed to the cylinder, and moreover, it is further desirable for the extruder in which the cylinder is formed with one or more vent portions.

Further, in the described embodiment 1, it is described that the gate 5 is disposed on the bisector M1 in the depth direction of the cavity 4. However, in consideration of the shape of the cavity 4, the gate 5 may be disposed on a portion apart from the bisector M1 in the depth direction of the cavity 4.

### EXAMPLE

An example of the preferred embodiment of the present invention will be described hereunder, but it is to be noted that the present invention is not limited to this example.

<Manufacture of Liquid Crystalline Polyester>

Two kinds of liquid crystalline polyesters (LCP1 and LCP2) were first prepared by two kinds of manufacturing methods (first and second manufacturing methods) mentioned hereinlater.

### (1) First Manufacturing Method

There was prepared a reactor vessel provided with an agitator, a torque meter, a nitrogen gas introducing pipe, a temperature meter and a reflux cooler, and p-hydroxyl benzoic acid of 994.5 g (7.2 mol), 4,4′-dihydroxy biphenyl of 446.9 g (2.4 mol), terephthalic acid of 299.0 g (1.8 mol), isophthalic acid of 99.7 g (0.6 mol) and acetic acid anhydride of 1347.6 g (13.2 mol) were stocked with the reactor vessel.

Then, after the internal air of the reactor vessel was sufficiently displaced with nitrogen gas, 1-methyl imidazol of 0.18 g was added to the nitrogen gas, the internal temperature of the reactor vessel was raised to 150° C. in 30 minutes under the presence of nitrogen gas flow and refluxed for 30 minutes while keeping this temperature. In a next stage, 1-methyl imidazol of 2.4 g was further added and the internal temperature of the reactor vessel was raised to 320° C. in 2 hours and 50 minutes while distilling away by-product acetic acid, unreacted acetic acid anhydride and the like. Thereafter, at a time when the torque was detected to be increased, the reaction was deemed to be finished, and the inner content was taken out of the reactor vessel.

In a subsequent stage, the thus obtained solid component was cooled to a room temperature, and then crushed by a rough crusher. Thereafter, under the nitrogen gas atmosphere, the crushed component was heated from the room temperature to 250° C. in one hour, then from 250° C. to 295° C. in 5 hours, and then, the temperature of 295° C. was kept for 3 hours, thus solid polymerization was performed.

Finally, the thus obtained component was cooled. Consequently, a liquid crystalline polyester (LCP1) was obtained. The flow starting temperature of LCP1 was 327° C.

It is noted that this flow starting temperature is a value measured by the Shimadzu Flow Tester CFT-500 (SHIMADZU CORPORATION) using a test material (liquid crystalline polyester) of about 2 g. That is, the specimen of about 2 g fills a cylinder to which a die provided with a nozzle having an inner diameter of 1 mm and a length of 10 mm and load of 9.8 MPa (100 kgf/cm²) is applied. Under this state, the test material is melt and extruded at temperature-increase speed of 4° C./min., and a temperature at which the melt viscosity indicates 4800 Pa·s (4800 poise) is measured, which is deemed as flow starting temperature.

### (2) Second Manufacturing Method]

A reactor vessel provided with an agitator, a torque meter, a nitrogen gas introducing pipe, a temperature meter and a reflux cooler was prepared, and p-hydroxyl benzoic acid of 994.5 g (7.2 mol), 4,4′-dihydroxyl biphenyl of 446.9 g (2.4 mol), terephthalic acid of 239.2 g (1.44 mol), isophthalic acid of 159.5 g (0.96 mol) and acetic acid anhydride of 1347.6 g (13.2 mol) were stocked with the reactor vessel.

Then, after the internal air of the reactor vessel was sufficiently displaced with nitrogen gas, 1-methyl imidazol of 0.18 g was added to the nitrogen gas, the internal temperature of the reactor vessel was raised to 150° C. in 30 minutes under the presence of nitrogen gas flow and refluxed for 30 minutes while keeping this temperature. In a next stage, 1-methyl imidazol of 2.4 g was further added and the internal temperature of the reactor vessel was raised to 320° C. in 2 hours and 50 minutes while distilling away by-product acetic acid, unreacted acetic acid anhydride and the like. Thereafter, at a time when the torque was detected to be increased, the reaction was deemed to be finished, and the inner content was taken out of the reactor vessel.

In a subsequent stage, the thus obtained solid component was cooled to a room temperature, and then crushed by a rough crusher. Thereafter, under the nitrogen gas atmosphere, the crushed component was heated from the room temperature to 220° C. in one hour, then from 220° C. to 240° C. in 0.5 hours, and then, the temperature of 240° C. was kept for 10 hours, thus solid polymerization was performed.

Finally, the thus obtained component was cooled. Consequently, a liquid crystalline polyester (LCP2) was obtained. The flow starting temperature of LCP2 was 286° C., which was a temperature lower than the flow starting temperature of the LCP1 by 41° C. The flow starting temperature of LCP2 was measured by the same method as the flow starting temperature of LCP1.

<Preparation of Liquid Crystalline Polyester Resin Compound>

The LCP1 and LPC2 prepared and obtained by the processes mentioned above were mixed at mass ratio of 55:45, and thereafter, Mica (manufactured by YAMAGUCHI MICA CO., LTD. as AB-25S) was combined by 43 parts by mass with respect to 100 parts by mass of the mixed resin. Thereafter, the thus combined material was melt and kneaded by using twin-axis-extruder “PCM-30” manufactured by IKEGAI Corp, thus pellet geometry liquid crystalline polyester resin compound was prepared.

<Warpage Analysis Data Acquisition>

With respect to the thus prepared liquid crystalline polyester resin compound, Young's modulus, Poisson ratio, linear coefficient of expansion (in flowing direction and direction perpendicular to the flowing direction of), thermal conductivity, specific heat, viscosity and specific volume were acquired as data for warpage analysis.

As a result, liquid crystalline polyester resin compound has Young's modulus of 5000 MPa, Poisson ratio of 0.31, linear coefficient of expansion in flowing direction of 6.12×10⁻⁶, linear coefficient of expansion in perpendicular direction 6.31×10⁻⁶, and thermal conductivity (25° C.) of 0.38 W/(m·K). As to the specific heat, twelve standard temperatures within 51-344° C. were measured to grasp temperature dependency of the specific heat, and in this measurement, the specific heat of 890-1519 J/kg·° C. was obtained. Furthermore, as to the viscosity, in order to obtain temperature dependence and shearing speed dependency of viscosity, the viscosity was measured at three standard temperatures of 325° C., 345° C., 365° C. and eight standard shearing speeds within 100-50000 s⁻¹, and as a measurement result, the viscosity of 2.3-865.1 Pa·s was obtained. Furthermore, as to the specific volume, in order to grasp the temperature dependency and pressure dependency of the specific volume, the specific volume was measured at fifty standard temperatures within 25.0-360.0° C. and at five standard pressures of 0 MPa, 50 MPa, 100 MPa, 150 MPa, 200 MPa, and as a measurement result, the specific volume of 0.6135-0.7054 cm³/g was obtained.

### Example 1 of the Present Embodiment

By using the thus obtained data for warpage analysis, the warpage amount (unit: millimeters) of an FPC connector having predetermined size (length of 18 mm, depth of 3 mm, height of 1 mm) in the length direction was calculated by means of numerical analysis in a case where the FPC connector was injection-molded by using a mold provided with only one gate is formed at a position apart inside by 6/100 length of the full length from the end portion of the longitudinal direction of the cavity (i.e., position L5/L4=6/100 in FIG. 2). This numerical analysis was performed by using Analysis Software “Moldflow Plastics Insight 2011” produced by Moldflow Corporation. The result of this analysis is shown in Table 1 mentioned herein later.

### Example 2 of the Present Embodiment

The warpage amount of an FPC connector in the longitudinal direction was calculated by numerical analysis with substantially the same conditions as those in the above Example 1 except that the position of the gate of the mold was shifted inside by 9/100 of the full length apart from the end portion in the longitudinal direction of the cavity. The result of this analysis is shown in the Table 1.

### Example 3 of the Present Embodiment

The warpage amount of an FPC connector in the longitudinal direction was calculated by means of numerical analysis with substantially the same conditions as those in the above Example 1 except that the position of the gate of the mold was shifted inside by 14/100 of the full length apart from the end portion in the longitudinal direction of the cavity. The result of this analysis is shown in the Table 1.

### Comparative Example 1

The warpage amount of an FPC connector in the longitudinal direction was calculated by means of the numerical analysis with substantially the same conditions as those in the above Example 1 except that the position of the gate of the mold was shifted inside by 25/100 of the full length apart from the end portion in the longitudinal direction of the cavity. The result of this analysis is shown in the Table 1.

### Comparative Example 2

The warpage amount of an FPC connector in the longitudinal direction was calculated by means of the numerical analysis with substantially the same conditions as those in the above Example 1 except that the position of the gate of the mold was shifted inside by 50/100 (i.e., central portion in the cavity longitudinal direction) of the full longitudinal from the end portion in the length direction of the cavity. The result of this analysis is shown in the Table 1.

### Comparative Example 3

The warpage amount (mm) of an FPC connector in the longitudinal direction was calculated by means of the numerical analysis with substantially the same conditions as those in the above Example 1 except that two gate were formed to the mold at positions shifted inside by 25/100 and 75/100 of the full length from the end portion in the longitudinal direction of the cavity. The result of this analysis is shown in the following Table 1.

TABLE 1

| | | | | Compar- | Compar- | Compar- |
|---|---|---|---|---|---|---|
| | | | | ative | ative | ative |
| | Exam- | Exam- | Exam- | Exam- | Exam- | Exam- |
| | ple 1 | ple 2 | ple 3 | ple 1 | ple 2 | ple 3 |
| Number | 1 | 1 | 1 | 1 | 1 | 2 |
| of gate | | | | | | |
| Gate | 6/100 | 9/100 | 14/100 | 25/100 | 50/100 | 25/100 |
| posi- | | | | | | 75/100 |
| tion/ | | | | | | |
| total | | | | | | |
| length | | | | | | |
| Amount | 0.037 | 0.040 | 0.045 | 0.052 | 0.048 | 0.050 |
| of | | | | | | |
| warpage | | | | | | |
| (mm) | | | | | | |

<Evaluation of Warpage of FPC Connector>

As is apparent from the Table 1, in consideration of the Comparative Example 2 as being a standard in which the single gate is formed to the center position in the longitudinal direction of the cavity (warpage amount of 0.048 mm), the results in the Comparative Example 1 (warpage amount of 0.052) and in the Comparative Example 3 (warpage amount of 0.050) exhibited that the warpage amounts in the Comparative Examples 1 and 3 exceed the warpage amount in the Comparative Example 2. On the other hand, the results in the Example 1 (warpage amount of 0.037), in the Example 2 (warpage amount of 0.040), and in the Example 3 (warpage amount of 0.045) of the present embodiment exhibited that the warpage amounts in the Examples 1 to 3 are less than the warpage amount in the Comparative Example 1. Accordingly, it was evidenced that the warpage of the FPC connector can be significantly suppressed by forming one gate to a position of the mold apart inside by 15/100 of the total length from the end portion in the longitudinal direction of the cavity of the mold in comparison with the case in which the gate is formed on the central position of the cavity length direction.

It is further to be noted that the present invention is not limited to the described embodiment and many other changes and modifications or alternations without departing from the scopes of the appended claims.

The present invention, for example is applicable to flexible printed circuit boards that can be incorporated or assembled in various electric or electronic machineries, equipments or components such as smartphone, digital camera, game machine and the like.

What is claimed is:

1. A method of manufacturing an FPC connector in which resin material is poured into a cavity defined by a mold through a gate formed to the mold so as to fill the cavity to thereby perform an injection molding of the FPC connector, wherein;
the injection molding is performed with using the mold comprising single gate formed at a position between one end portion of the cavity and a portion apart inside by 15/100 of a full length of the cavity from one end in a longitudinal direction thereof.

2. The method of manufacturing an FPC connector according to claim 1, wherein the resin material is a liquid crystalline polyester.

3. The method of manufacturing an FPC connector according to claim 1, wherein the resin material is a liquid crystalline polyester resin compound which is prepared by combining the liquid crystalline polyester with at least one of filler selected from glass fiber, talc, and mica.

4. The method of manufacturing an FPC connector according to claim 1, wherein the gate is formed on a bisector in a depth direction of the cavity of the mold.

5. The method of manufacturing an FPC connector according to claim 1, wherein the FPC connector has pin insertion holes of 10 or more than 10 in number and the pin insertion hole has a pitch of not more than 0.6 mm.
